(19) United States
(12) Patent Application Publication
(10) Pub. No.: US 2012/0074052 A1
(43) Pub. Date: Mar. 29, 2012

(54) Chemical dispenser

(76) Inventor: John Brandreth, Canton, GA (US)

(21) Appl. No.: 12/924,221

(22) Filed: Sep. 23, 2010

(51) Int. Cl. C02F 1/68; B01D 11/02; B01D 35/00

(52) U.S. Cl. 210/206; 422/277; 422/261

(57) ABSTRACT

A chemical dispensing device for delivering chemical solutions into a liquid flow, alone or in combination with a filter cartridge, wherein said chemical solution is created by dissolving solid chemical contained within a chemical cartridge, the device having an upper conduit member with a sealing flange, flow openings, an internal wall and a dispensing aperture, and a chemical containing lower cartridge, the cartridge having an intake aperture located on the upper portion of its side wall, such that a saturated chemical solution is formed in the cartridge and passes into liquid flowing through the upper conduit member through the dispensing aperture due to the pressure differential of the liquid flowing into through the flow openings of the upper conduit.

### BACKGROUND OF THE INVENTION

This invention relates generally to the field of dispenser devices used to introduce into a flowing liquid small quantities of a chemical solution created by dissolving a solid or granular chemical. More particularly, the invention relates to such devices to be used as a component in assemblies of the type commonly used for filtration of water in circulation or supply systems, where the rate of introduction of the dissolved chemical into the water is controlled in a manner related to the flow volume of the water stream to insure proper concentration percentage.

It is desirable or necessary in many water supply or recirculation systems, such as water for household or industrial use, or water for use in spas and pools, to add certain chemicals to the water to control bacteria or fungal growth, corrosion, scale deposits, etc. Commonly known additives include chlorine, polyphosphate or sodium silicate. Such additives are typically supplied in solid or granular form for ease of handling, and must therefore be dissolved in liquid and introduced into the water flow. It is imperative that the chemical additives be supplied in the proper concentration, and it is important that the mechanism for adding the chemical solutions provide for proper rate introduction with little variation in concentration. Many conventional systems fail these criteria, the mechanisms being unable to prevent variations in concentration and introduction rates, especially in circumstances where the water flow is not continuous and varies in pressure.

Simplistic solid chemical additive mechanisms simply divert all or a portion of the water flow stream through a container holding the solid chemical. The water flowing from the container will include an amount of dissolved chemical. These devices suffer from lack of dispensing control, since the amount of chemical present in the outflow is dependent on the volume of solid chemical in the container. As that volume decreases, the concentration of dissolved chemical in the outflow also decreases. Additionally, this type of system produces a highly concentrated chemical surge when water flow is resumed after being shut off for a period of time. Finally, variation in the water flow rate will not correspondingly alter the dissolving rate of the chemical, producing incorrect concentration amounts in the outflow.

The problems set forth above have been addressed through various devices in my earlier patents U.S. Pat. No. 5,580,448, issued Dec. 3, 1996, U.S. Pat. No. 6,267,886, issued Jul. 31, 2001, U.S. Pat. No. 6,280,617, issued Aug. 28, 2001, and U.S. Pat. No. 6,855,252, issued Feb. 15, 2005, the disclosures of which are incorporated herein by reference.

A majority of water filtering devices utilize a removable filter cartridge retained within a flow-though housing. The filter cartridge is typically a cylindrical member having a hollow interior or bore, open on both ends, wherein the body of the cartridge is porous. The body may be composed for example of a carbon block or sediment filtration material. When placed into the housing, one end of the cartridge is sealed and the water to be filtered is delivered around the exterior of the cartridge, passes through the porous filter body into the hollow interior, and then exits through the open end of the cartridge. As representative examples, the filter cartridges are typically manufactured in standard sizes approximately 10 or 20 inches in length with approximately 2.5 or 4 inch outer diameters and an internal bore of approximately 1 inch in diameter. By standardizing the filter cartridges and correspondingly the filter housings, the components are interchangeable and replaceable. The cartridges are typically provided with end caps having a planar end wall, a tubular throat member and an annular gasket-receiving flange to receive a washer gasket that mates with the retention structure of the housing.

It is an object of this invention to provide a chemical dispenser device which provides a steady state concentration of dissolved chemical, which introduces the chemical solution into the main water stream in amounts directed related to water flow rate or volume to maintain precise percentages of chemical solution, which does not produce excessive chemical concentration during periods of no water flow, and which does not introduce excessive amounts of dissolved chemical when water flow is resumed, wherein the dispenser device is structured as a universal component that can be utilized in combination with standard filter cartridges as described above. It is an object to provide such a device where the cartridge containing the solid chemical is not a flow through cartridge, such that water is not passed through the solid chemical. It is an object to provide such a device which is removable and replaceable, such that a spent dispenser device can be replaced with a fresh device, or an unspent device can be removed from a clogged filter and used with a replacement filter.

### SUMMARY OF THE INVENTION

The invention comprises a chemical dispensing device which is structured to be incorporated within a flow-through filter cartridge for water purification, the filter cartridge having a hollow interior or bore, open on both ends, wherein the body of the cartridge is porous. The body may be composed for example of a carbon block or sediment filtration material. When placed into a housing, one end of the cartridge is sealed and the water to be filtered is delivered around the exterior of the cartridge, passes through the porous filter body into the hollow interior, and then exits through the open end of the cartridge.

The chemical dispensing device, generally tubular in form, comprises a lower portion chemical cartridge member having an open top, a closed bottom, and a hollow interior within which is deposited a solid or granular chemical treatment substance. The chemical dispensing device further comprises an upper conduit having an open top surrounded by a sealing flange member, flow openings for large volume water flow, an internal wall having a relatively small dispensing aperture, at least one relatively small intake aperture positioned below said internal wall, and an open bottom. The chemical cartridge member and upper conduit member are sized such they may be coaxially mated, the open top of the chemical cartridge member being in communication with the open bottom of the upper conduit member.

The sealing flange member extends radially outward in a transverse plane perpendicular to the central axis of the upper conduit, and is of sufficient size to seal off the open end of the filter cartridge external to the upper conduit when the dispensing device is inserted into the hollow interior of the filter cartridge, such that the only exit for water flow is through the chemical dispensing device. The sealing flange member will be entrapped by the end of the filter cartridge and the retention means of the housing, usually in combination with a washer gasket, such that the dispensing device will not be ejected from the filter cartridge during water flow.

Once the dispensing device is installed within the cartridge filter and its housing and water flow is initiated, the pressure differential caused by the large volume flow of water into the flow conduits and across the small dispensing aperture in the internal wall draws a small amount of dissolved chemical solution through the dispensing aperture and into the main water flow stream, while simultaneously drawing an equally small amount of water into the upper interior of the chemical cartridge through the intake aperture to replace the suctioned chemical solution. Because the chemical cartridge has only relatively small openings in relation to the internal volume of the chemical cartridge, the solution contained within the cartridge portion of the dispensing device becomes chemically saturated within a short time after water is first introduced through the filter cartridge. The solution within the chemical cartridge remains saturated even when water flow is occurring, since the amount of water drawn into the small intake aperture to replace the amount of chemical solution drawn out of the small dispensing aperture is proportionately small relative to the total volume of the saturated solution contained within the chemical cartridge. Because the solution in the cartridge is saturated, there will be no change in concentration during periods when no water flow is occurring.

### BRIEF DESCRIPTION OF THE DRAWINGS

FIG. 1 is an expanded view of the dispensing device showing the chemical cartridge member separated from the upper conduit member.

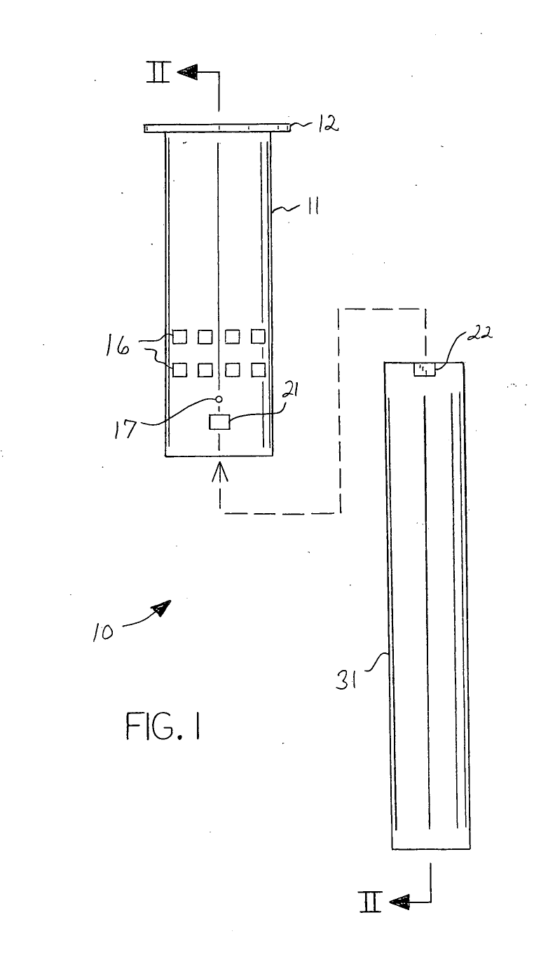

FIG. 2 is a cross-sectional view taken along line II-II of FIG. 1, showing the dispensing device inserted within a cylindrical filter cartridge of typical structure.

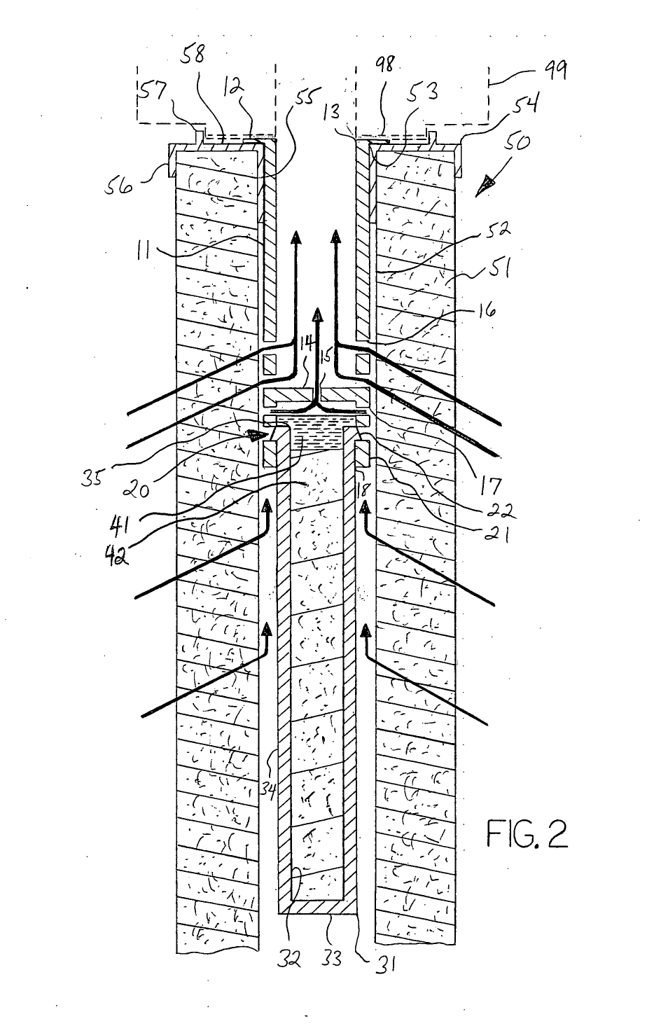

### DETAILED DESCRIPTION OF THE INVENTION

The invention will now be described in detail, in conjunction with the drawings, with regard for the best mode and preferred embodiment. The invention is a chemical dispensing device for introducing a chemical solution of predetermined concentration and amount into a flow of liquid, the dispenser being incorporated within an adjoined housing and cylindrical filter cartridge connected to inflow and outflow conduits of a water or other liquid delivery system, such as found in a residential or industrial setting for one-time use or recirculation, such as for example for a spa or pool. The chemical treatment substance is presented in a solid or granular form within the chemical dispensing device and dissolves to create a saturated solution to be introduced into the water flow stream, the chemical being of any soluble type which imparts beneficial properties to the water, such as prevention of bacterial, fungal, mold or other biological growth, reduction or control of deposits of scaling, etc.

The invention is a chemical dispensing device 10, alone or in combination with a standard filter cartridge member 50. A standard filter cartridge member 50 comprises a tubular porous filter body 51 having a hollow core 52, and an end cap 54 on each end, one of which in use defines an outflow opening 53. The end cap 54 comprises a tubular throat member 55 extending a short distance into the core 52, a shoulder flange 56 encircling the ends of the filter body 51, a generally planar end wall 58 transverse to the central axis, and usually an annular gasket-retaining recess or flange 57 extending in the axial direction.

With reference to the drawings, the invention is seen in the illustrated embodiment to comprise a chemical dispensing device 10 of generally tubular configuration, the dispensing device 10 comprising a thin-walled upper conduit member 11 having an open top 13 and an open bottom 18. A transverse internal wall member 14, extending perpendicularly relative to the central axis of the upper conduit 11, is positioned near the open bottom 18. A preferably centrally located dispensing aperture 15 is disposed in the internal wall member 14 to allow passage of a saturated chemical solution 41 through the internal wall member 14 and into the upper conduit 11. A plurality of flow openings 16 are positioned in the wall of the upper conduit member 11, the flow openings 16 being disposed generally adjacent to the internal wall member 14 on the outflow side of the upper conduit member 11. The total area of flow openings 16 should be of sufficient amount so as not to impede flow of water through the device. At least one intake aperture 17 is disposed in the wall of the upper conduit member 11 generally adjacent to the internal wall member 14 toward the open bottom end of the upper conduit member 11, i.e., on the opposite side of the internal wall member 14 from the flow openings 16.

The chemical dispensing device 10 further comprises a generally tubular, chemical-retaining cartridge member 31 comprising an open top 35, a side wall 34 and a closed bottom 33 that together define a hollow interior 32. The chemical-retaining cartridge member 31 is coaxially joined to the upper conduit member 11. The means 20 for connecting the cartridge member 31 and upper conduit 11 may comprise as shown a pair of notches disposed in the upper conduit 11 and a pair of corresponding projecting lug members 22, whereby the open top end of the cartridge member 31 may be inserted into the open bottom 18 of the upper conduit member 11 such that the lug members 22 lock into the notches 21. The upper conduit member 11 and the cartridge member 31 may be permanently or temporarily joined, and the connection means 20 may comprise mechanisms or joining means differing from that set forth in the drawings, such as for example threading, bonding or the like. The hollow interior 32 of the cartridge member 31 retains a solid or granular chemical treatment substance 42 and the combination of the cartridge member 31 and the internal wall member 14 of the upper conduit retain a saturated chemical solution 41 formed when the chemical treatment substance 42 dissolves.

Most importantly, the chemical dispensing device 10 further comprises a transverse sealing flange member 12, the sealing flange member 12 being disposed at the open top 13 of the upper conduit member 11. The sealing flange member 12 extends radially outward from open top 13, perpendicularly to the central axis of the upper conduit member 11, and is a relatively thin member presenting generally planar upper and lower surfaces. The sealing flange member 12 is adapted to be received and retained between the end wall 58 of a cylindrical filter cartridge member 50 and the retention structure 99 of the housing containing the filter cartridge member 50, typically in combination with a washer gasket 98 that is compressed by the retention structure 99 of the housing, such combinations of filter cartridge 50 and housing being well known in the art. The perimeter of the sealing flange member 12 extends radially from the wall of the upper conduit 11 sufficient distance to abut a portion of the end wall 58 and thus seal the outflow opening 53 of the filter cartridge member 50 on the exterior side of the upper conduit 11, such that all water exiting the filter cartridge member 50 must flow through the dispensing device 10 for treatment. A sealing flange member 12 having an outer radius of approximately 1.375 inches is suitable for use with most filter cartridge members 50.

The structure of the dispensing device 10 allows for the insertion of the combined upper conduit member 11 and chemical-retaining cartridge member 31 into the hollow core 52 of the filter cartridge member 50, such that only the sealing flange member 12 remains external to the filter cartridge member 50. Because the sealing flange member 12 retains the dispensing device 10 at the end of the filter cartridge member 50 containing the outflow opening 53, the device 10 can be utilized with filter cartridges 50 of varying lengths and varying external diameters. The outer diameter of the upper conduit member 11 is slightly smaller than the interior diameter of the hollow core 52 of the filter cartridge member 50 so that water passing through the filter cartridge body 51 can readily reach the flow openings 16.

With the dispensing device 10 in place and the filter cartridge 50 retained within the housing of the filtering apparatus, water is directed to the exterior of the filter cartridge 50. The housing is structured such that the only flow path for the water is through the porous filter body 51 into the hollow core 52. Because the outflow opening 53 to the exterior of the upper conduit 11 is sealed by the sealing flange member 12, water passes into the chemical dispensing device through the intake apertures 17 and the flow openings 16, with the vast majority of the water passing through the flow openings 16.

Dispensing aperture 15 and intake apertures 17 are sized relatively small in comparison to the interior volume of cartridge member 31 and in comparison to the total area of flow openings 16 above the internal wall 14. For example, in a dispensing device 10 having an internal diameter of approximately 1 and ⅛ inches and a cartridge height of approximately 4 and ¾ inches, the dispensing aperture 15 in internal wall 14 and the intake apertures 17 in the wall of the upper conduit 11 should be between approximately 1/32 and 3/16 inches in diameter. Preferably, the size of the dispensing aperture 15 should be generally equal to the total combined sizes of the intake apertures 17. The size of the intake apertures 17 and dispensing aperture 15 determine the feed rate of the saturated chemical solution 41 into the water flow, and can be varied in relation to the solubility characteristics or desirable concentrations of particular solid chemicals 42 needed for a given application.

Upon Initial use, water passing through the at least one intake aperture 17 fills any voids within the chemical-retaining cartridge member 31 and comes into contact with the chemical treatment substance 42. Because of extended residence time, a saturated chemical solution 41 is created. Once the saturated chemical solution 41 is established, the large volume of water flowing through the flow openings 16 creates a pressure differential that suctions some of the saturated chemical solution 41 through the dispensing aperture 15, which in turn draws water through the intake apertures 17 to replace the liquid within the chemical-retaining cartridge member 31. The chemical solution 41 mixes with the turbulent water passing through the flow openings 16 of the upper conduit member 11, insuring that the water exiting the chemical dispenser device 10 is properly treated.

The amount of saturated treatment solution 41 drawn through the dispensing aperture 15 is a function of aperture size, which is predetermined, and water flow rate. As water flow rate increases the pressure differential is increased and more solution 41 is drawn out and, conversely, as water flow rate decreases the pressure differential decreases and less solution 41 is drawn out. This insures that the proper amount of saturated chemical solution 41 is introduced into the water flow no matter what flow rate is present. In addition, since the amount of saturated solution 41 drawn from the chemical cartridge 31 is relatively small in comparison to the total volume of saturated solution 41, and since the water drawn through intake aperture 17 is likewise of small amount relative to the total volume of the saturated solution 41, the solution 41 within the cartridge 31 remains in a constant, fully saturated condition. The chemical solution 41 remains at the same concentration within the cartridge 31 no matter what amount of solid chemical treatment substance 42 is present in the cartridge 31, since the solution 41 is always at a saturated level. Because the refilling intake aperture 17 is located above the cartridge member 31, the replacement water flows into the dissolved chemical solution 41 rather than into the solid or granular chemical 42, so no surging or super-saturation can occur from flow or turbulence effects within the cartridge 31.

It is contemplated that equivalents and substitutions for certain elements described and illustrated above may be obvious to those skilled in the art, and therefore the true scope and definition of the invention is to be as set forth in the following claims.

I claim:

1. A chemical dispenser device adapted to introduce a chemical solution into a flow of liquid, said device comprising:
an upper conduit member comprising a tubular wall, an open top, a sealing flange extending radially outward from said open top, a plurality of flow openings disposed in said tubular wall, a transverse internal wall member, a dispensing aperture disposed in said internal wall member, at least one intake aperture disposed in said tubular wall on the opposite side of said internal wall member from said flow openings, and an open bottom;
a chemical-retaining cartridge member comprising a closed bottom, a tubular side wall, and an open top, said bottom and side wall defining an interior and containing a chemical in solid form, said open top of said cartridge member being connected with said open bottom of said upper conduit member;
whereby liquid entering said cartridge member through said at least one intake aperture contacts said chemical to dissolve said chemical and form a saturated chemical solution within said cartridge interior, and whereby said saturated chemical solution exits said cartridge member through said dispensing aperture in response to liquid flow through said flow openings in said upper tube member.

2. The device of claim 1, wherein the size of said at least one intake aperture and said dispensing aperture are small relative to the size of said flow openings.

3. The device of claim 2, wherein said at least one intake aperture and said dispensing aperture are between 1/32 and 3/16 inches in diameter.

4. The device of claim 1, wherein said at least one intake aperture is positioned adjacent said internal wall member.

5. The device of claim 1, wherein said flow openings are positioned adjacent said internal wall member.

6. The device of claim 4, wherein said flow openings are positioned adjacent said internal wall member.

7. A chemical dispenser device adapted to introduce a chemical solution into a flow of liquid, said device comprising:
an upper conduit member comprising a tubular wall, an open top, a sealing flange extending radially outward from said open top, a plurality of flow openings disposed in said tubular wall, a transverse internal wall member, a dispensing aperture disposed in said internal wall member, and at least one intake aperture disposed in said tubular wall on the opposite side of said internal wall member from said flow openings;
a chemical-retaining cartridge member comprising a closed bottom and a tubular side wall, said bottom and side wall defining an interior and containing a chemical in solid form, said cartridge member coaxially joined with said upper conduit member;
whereby liquid entering said cartridge member through said at least one intake aperture contacts said chemical to dissolve said chemical and form a saturated chemical solution within said cartridge interior, and whereby said saturated chemical solution exits said cartridge member through said dispensing aperture in response to liquid flow through said flow openings in said upper tube member.

8. The device of claim 7, wherein the size of said at least one intake aperture and said dispensing aperture are small relative to the size of said flow openings.

9. The device of claim 8, wherein said at least one intake aperture and said dispensing aperture are between 1/32 and 3/16 inches in diameter.

10. The device of claim 7, wherein said at least one intake aperture is positioned adjacent said internal wall member.

11. The device of claim 7, wherein said flow openings are positioned adjacent said internal wall member.

12. The device of claim 10, wherein said flow openings are positioned adjacent said internal wall member.

13. A chemical dispenser device in combination with a filter cartridge member, said combination adapted to introduce a chemical solution into a flow of liquid;
said filter cartridge member comprising a tubular porous filter body having a hollow core defining an outflow opening;
said chemical dispenser device comprising:
an upper conduit member comprising a tubular wall, an open top, a sealing flange extending radially outward from said open top, a plurality of flow openings disposed in said tubular wall, a transverse internal wall member, a dispensing aperture disposed in said internal wall member, and at least one intake aperture disposed in said tubular wall on the opposite side of said internal wall member from said flow openings;
a chemical-retaining cartridge member comprising a closed bottom and a tubular side wall, said bottom and side wall defining an interior and containing a chemical in solid form, said cartridge member coaxially joined with said upper conduit member;
whereby liquid entering said cartridge member through said at least one intake aperture contacts said chemical to dissolve said chemical and form a saturated chemical solution within said cartridge interior, and whereby said saturated chemical solution exits said cartridge member through said dispensing aperture in response to liquid flow through said flow openings in said upper tube member;
wherein said upper conduit and said chemical-retaining cartridge member of said chemical dispenser device are disposed within said hollow core of said filter cartridge member at said outflow opening, and said sealing flange member is disposed externally to said hollow core.

14. The combination of claim 13, said filter cartridge member further comprising an end cap comprising a tubular throat member extending a short distance into said hollow core, a shoulder flange encircling the ends of the filter body, a generally planar end wall transverse to the central axis;
wherein said sealing flange member of said chemical dispenser device abuts said planar end wall of said filter cartridge member.

15. The combination of claim 14, said filter cartridge member further comprising an annular gasket-retaining flange extending in the axial direction.

16. The device of claim 13, wherein the size of said at least one intake aperture and said dispensing aperture are small relative to the size of said flow openings.

17. The device of claim 16, wherein said at least one intake aperture and said dispensing aperture are between 1/32 and 3/16 inches in diameter.

18. The device of claim 13, wherein said at least one intake aperture is positioned adjacent said internal wall member.

19. The device of claim 13, wherein said flow openings are positioned adjacent said internal wall member.

20. The device of claim 18, wherein said flow openings are positioned adjacent said internal wall member.
